(19) United States
(12) Patent Application Publication
(10) Pub. No.: US 2009/0223095 A1
(43) Pub. Date: Sep. 10, 2009

(54) HITCHING SYSTEM FOR ROAD CONSTRUCTION TRACTOR

(76) Inventors: Mark Anthony Klein, Metamora, IL (US); Lisa Ann South-Klein, Metamora, IL (US)

Correspondence Address: HUSCH BLACKWELL SANDERS LLP, 190 CARONDELET PLAZA, SUITE 600, ST. LOUIS, MO, 63105-3441, US

(21) Appl. No.: 12/399,305

(22) Filed: Mar. 6, 2009

Related U.S. Application Data
(60) Provisional application No. 61/035,174, filed on Mar. 10, 2008.

(51) Int. Cl. E02F 3/64; B60D 1/06; E02F 3/65

(52) U.S. Cl. 37/412; 280/511; 37/417

(57) ABSTRACT

The present invention is a hitching system for attaching a trailer to a tractor. The tractor includes a frame, a front axle, and rear axle. The trailer includes a frame and a gooseneck arm extending from the frame. A hitch-receiver pair is provided to fixedly attach the trailer to the tractor. One of the hitch and the receiver is attached to the gooseneck arm, and the other of the hitch and the receiver is attached to the tractor frame above and ahead of the rear axle. The hitch is configured to freely rotate with respect to the receiver by freely pivoting, pitching, and oscillating.

### CROSS-REFERENCE TO RELATED APPLICATIONS

The present application claims priority to provisional U.S Patent Application Ser. No. 61/035174 filed Mar. 10, 2008.

### BACKGROUND OF THE INVENTION

1. Field of the Invention

This invention relates in general to a hitching system and, in particular, to a hitching and support system for a tractor scraper. More specifically, but without restriction to the particular use which is shown and described, this invention relates to a hitching and support system providing a single joint or interface between the tractor and the trailer that allows rotation of the hitch through pivot, oscillation, and pitch. Preferably, the joint consists of a ball that freely rotates or a hitch receiver including a plurality of pins, wherein each pin allows one of pivot, oscillation, and pitch of the system.

2. Related Art

Tractor scrapers are used in many construction applications, such as road building, wherein the scraper is used to transport heavy loads of material such as dirt, rock, and gravel over rough terrain from one location to another for leveling or filling the terrain. The scraper comprises a tractor and an earthmoving trailer which are coupled via a hitch extending from the trailer and a hitch receiver coupled to the tractor. Typically, the hitch receiver is coupled to a back end of the tractor. Accordingly, a majority of the weight from the trailer is transferred to the back wheels of the tractor, often causing the front wheels of the tractor to be lifted from the ground. Specifically, in at least one known tractor scraper, approximately 23% of the scraper's weight is carried by a tongue of the hitch and 77% of the weight is carried by the rear wheels of the tractor.

Other trailers are coupled to the tractor via a gooseneck that more evenly distributes the weight of the trailer. However, according to the teaching of a prior invention, the gooseneck should be coupled to the tractor with a kingpin. The kingpin is used in a complicated system to adjust the relative pitch and oscillation angles between the scraper pan and the tractor, and substantially limits freedom of movement between the scraper and the tractor. Specifically, oscillation and pivoting of the scraper relative to the tractor is severely limited. Accordingly, such tractor scrapers often have a complicated hitch connection that includes several components to provide oscillation and pivot to the scraper. These complicated connections often result in an increased amount of maintenance and costs associated with operating and maintaining the tractor scraper. Moreover, the complicated design prohibits easily and quickly connecting and disconnecting the trailer from the tractor.

It is, therefore, an object of this invention to improve hitching systems for tractor scrapers by providing a single hitch connection that allows free rotation of the hitch while also substantially evenly distributing the weight of the trailer among the wheels of the tractor. Another object of this invention is to improve the amount of time and ease with which the trailer can be connected to and disconnected from the tractor.

### SUMMARY OF THE INVENTION

The present invention is a hitching system for a tractor scraper that includes a tractor and a scraper attached thereto. The tractor includes a frame and a front and rear axle that are each attached to the frame. The scraper includes a frame and a gooseneck arm extending from the frame. A hitch-receiver pair is provided to fixedly attach the trailer to the scraper. The hitch-receiver pair includes a receiver and a hitch fixedly attach to the receiver. One of the hitch and the receiver is attached to the gooseneck arm, and the other of the hitch and the receiver is attached to the tractor frame above and ahead of the rear axle.

The hitch is configured to freely rotate with respect to the receiver. Specifically, the hitch freely pivots, pitches, and oscillates with respect to the receiver. In one embodiment, the hitch is a spherical interface and the receiver is a socket configured to receive the spherical interface. In another embodiment, the hitch is multi-joint hitch that includes a pivot component, a pitch component, and an oscillation component.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIGS. 1(a) and 1(b) are schematic illustrations of a tractor scraper.

FIG. 2 is a schematic illustration of one embodiment of the hitch receiver pair shown in FIG. 1.

FIG. 3 is a schematic illustration of another embodiment of the hitch-receiver pair shown in FIG. 2.

FIG. 4 is schematic illustration of the pivot range of the hitch-receiver pair shown in FIG. 1.

FIG. 5 is a schematic illustration of the oscillation range of the hitch-receiver pair shown in FIG. 1.

FIGS. 6(a) and 6(b) are schematic illustrations of the pitch range of the hitch-receiver pair shown in FIG. 1.

FIGS. 7(a) and 7(b) are schematic illustrations of the location of the hitch-receiver pair shown in FIG. 1.

FIG. 8 is a view of the tractor shown in FIG. 1 having a water wagon attached thereto.

FIG. 9(a) is a top view of the locking mechanism shown in FIG. 2 in a closed position.

FIG. 9(b) is a top view of the locking mechanism shown in FIG. 9(a) in an open position.

### DETAILED DESCRIPTION OF THE PREFERRED EMBODIMENTS

The following description of the preferred embodiment(s) is merely exemplary in nature and is in no way intended to limit the invention, its application, or uses.

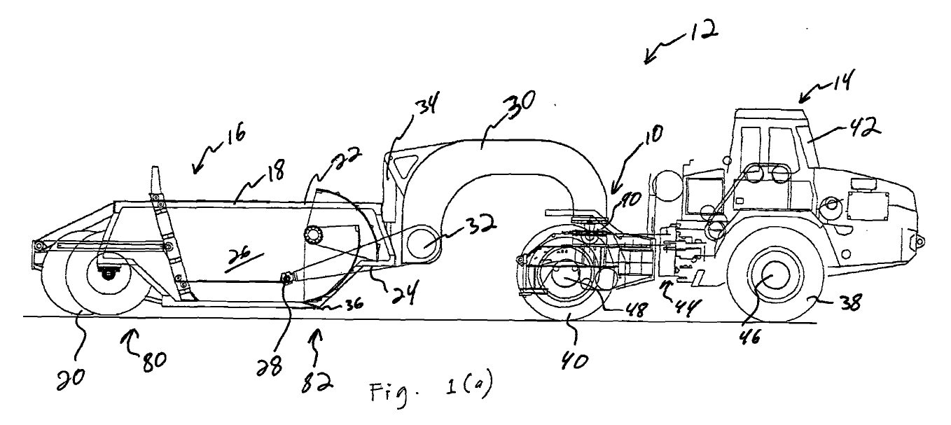

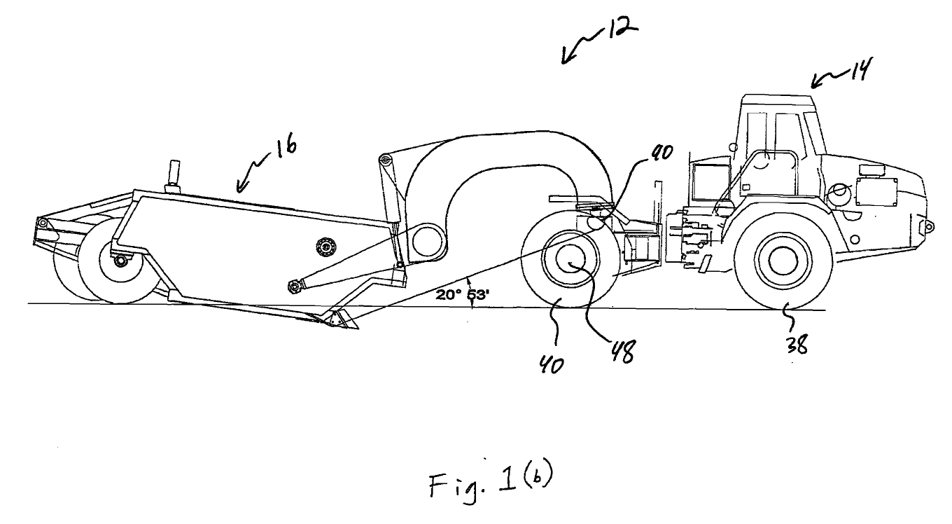

Referring now to FIGS. 1-8 there is shown a hitching system 10 for a tractor scraper 12. Although the hitching system disclosed herein maybe used with various vehicles, for convenience of illustration the preferred embodiment is illustrated with reference to its use with a six-wheel, three-axle tractor scraper.

Generally, a tractor scraper 12, as illustrated in FIG. 1 includes a tractor 14 and a trailer 16 that has a bin 18 supported at its rear end 80 by a pair of wheels 20 and at its front end 82 by a frame 22. The bin 18 has vertical sidewalls 26 that extend between the front end 82 and the rear end 80. Frame 22 has a pair of arms 24 pivotally connected to the vertical sidewalls 26 of the bin 18 by a pivot axis 28. Frame 22 also includes a gooseneck arm 30 coupled to anus 24 via a pivot axis 32 and extending forward from front end 82.

A hydraulic jack 34 couples bin 18 to gooseneck arm 30 so that bin 18 can be raised and lowered relative to the ground. Specifically, the bin 18 includes a blade 36 that spans across the front end 82 and excavates earth as the tractor scraper 12 passes along the ground. An amount of material removed as the scraper 12 passes is controlled by raising or lowering the blade 36 of the bin 18. The blade 36 is positioned by operating the hydraulic jack 34 to rotate the blade 36 upward and downward. More specifically, hydraulic jack 34 is expanded or contracted to determine the depth of the blade 36 with respect to the ground. Bin 18 is positioned directly behind the blade 36 to receive dirt severed from the terrain by the blade 36.

A rotating apron or gate is provided near the front end 82 of bin 18. The gate forms an operable front wall for the bin 18 that extends laterally between the bin sidewalls 26. The gate rotates about a pivot axis to open so that dirt severed from the terrain is forced backward into the bin 18. When the bin 18 is filled with dirt, the apron is lowered to its closed position so that the load can be carried to its ultimate place of disposal.

The tractor 14 is supported by a front pair of wheels 38 on a front axle 46 and a rear pair of wheels 40 on a rear axle 48 coupled to a frame 44. Tractor 14 includes an operator cab 42 having an instrument and control panel for controlling the tractor scraper 12 as well as to monitor or adjust various accessory or auxiliary equipment of the tractor scraper 12. Fluid conduits and/or hoses extend from tractor 14 and are turned across the gooseneck arm 30 to supply fluid hydraulic jack 34 to permit an operator in the cab 42 to control functions of the depth of blade 36.

The trailer 16 is joined to the tractor 14 by means of a hitch-receiver pair 90 that includes a hitch 50 and a receiver 52, as illustrated in FIG. 2. In the illustrated embodiment, hitch 50 is coupled to gooseneck arm 30 and receiver 52 is coupled to tractor 14; however, in an alternative embodiment, hitch 50 may be coupled to tractor 14 and receiver 52 may be coupled to gooseneck arm 30. Hitch-receiver pair 90 provides a single joint or interface 54 to couple the gooseneck arm 30 of trailer 16 to tractor 14 without a king pin. The single interface 54 enables a quick and easy connection and disconnection between the trailer 16 and the tractor 14.

Preferably, hitch-receiver pair 90 is fixedly attached to tractor 14 approximate to rear axle 48 between rear axle 48 and front axle 46. More specifically, hitch-receiver pair 90 is fixedly attached above and ahead of rear axle 48. In the exemplary embodiment illustrated in FIGS. 7(a) and 7(b), hitch-receiver pair 90 is fixedly attached 16 inches ahead of rear axle 48 and 26.13 inches above rear axle 48. Also, as illustrated in FIG. 1(b), hitch-receiver pair 90 is fixedly attached to tractor 14 at a vector angle of 20 degrees and 53 minutes. Accordingly, a small moment arm is provided to reduce the possibility of wheels 40 leaving the ground while operating tractor scraper 12. Hitch-receiver pair 90 is also preferably centered between a first side 56 of tractor 14 and a second side 58 of tractor 14.

The position of hitch-receiver pair 90 facilitates supporting trailer 16 by distributing the weight of trailer 16 between wheels 40 of tractor 14 and gooseneck 30. Specifically, the position of hitch-receiver pair 90 distributes approximately 33-40% of the weight of trailer 16 on gooseneck 30 and approximately 60-67% of the weight on rear wheels 40 of tractor 14. Accordingly, the position of hitch-receiver pair 90 hitch-receiver pair 90 also facilitates keeping the wheels 38 and 40 of tractor 14 in contact with the ground so that proper traction can be maintained. In the exemplary embodiment, a base plate 60 is coupled to tractor frame 44 at interface 54. Receiver 52 is fixedly attached to base plate 60 in the illustrated embodiment; however, as described above, hitch 50 can be fixedly attached to base plate 60.

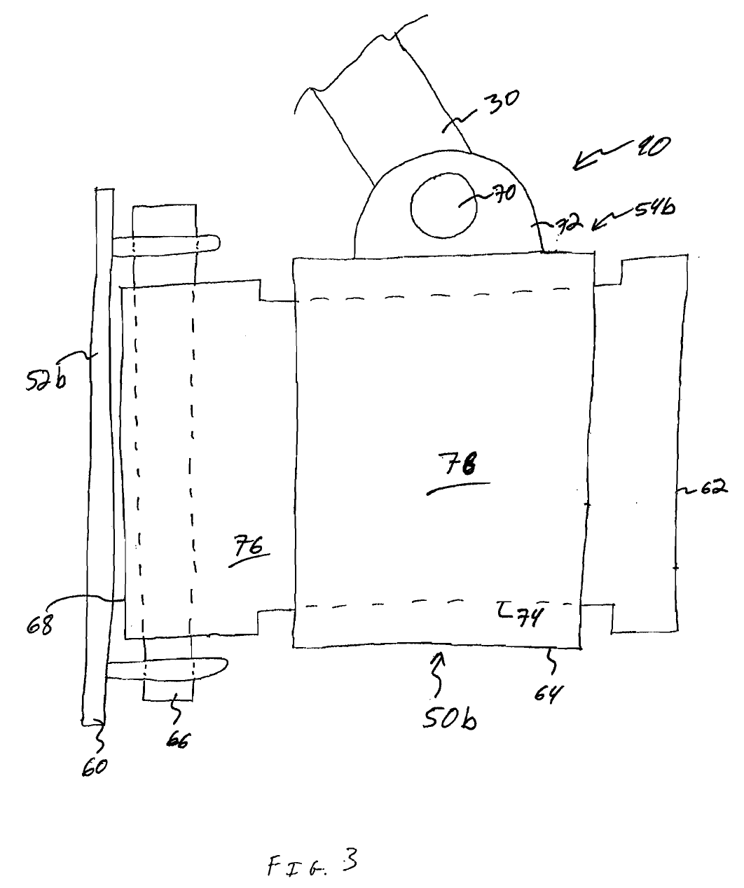

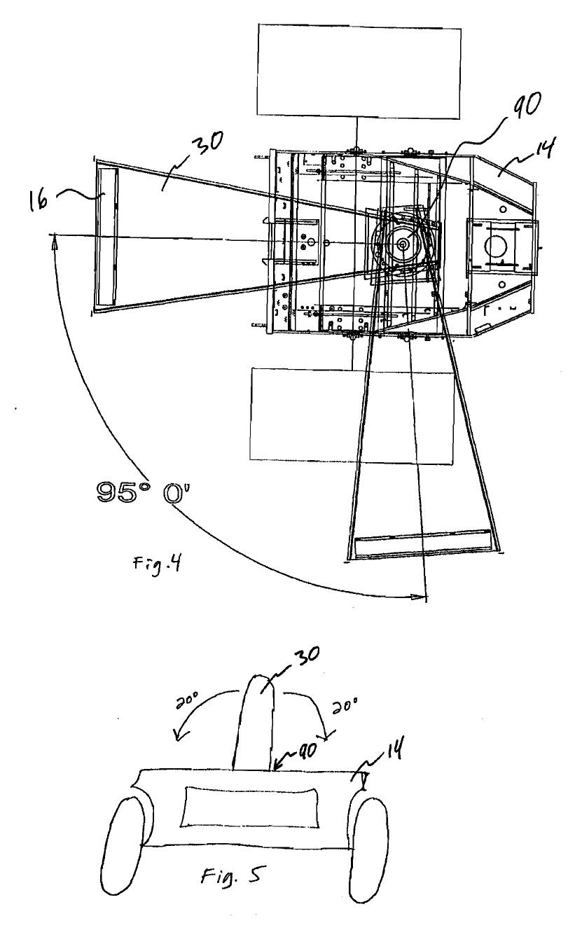

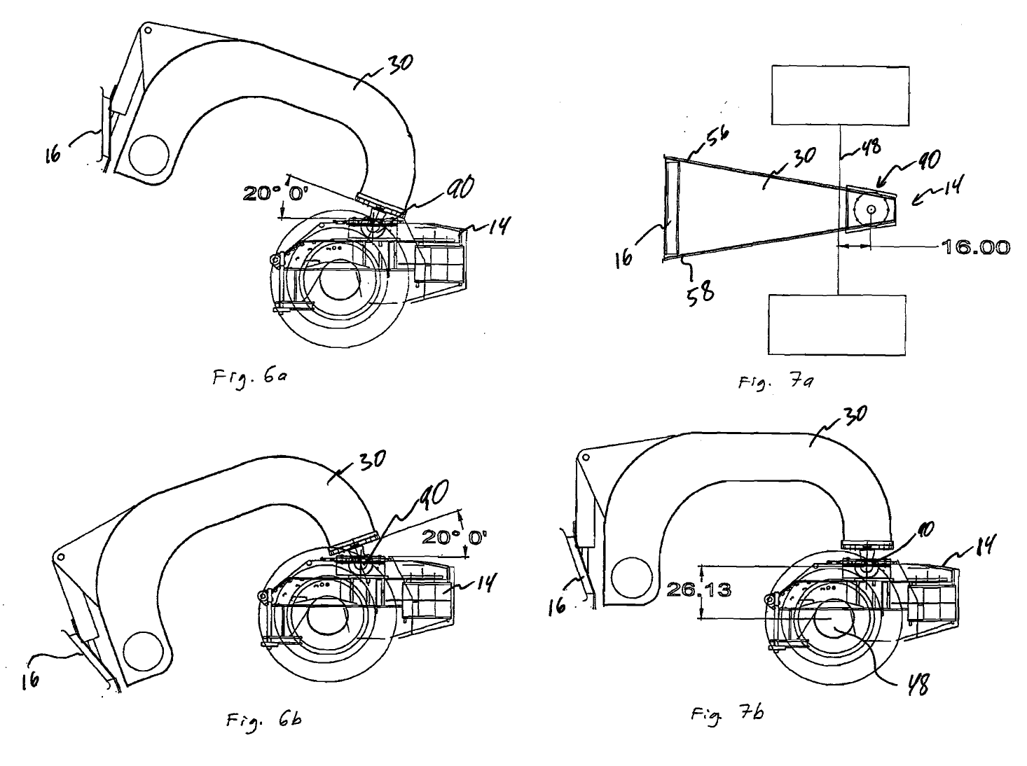

Hitch-receiver pair 90 enables free rotation of trailer 16 with respect to tractor 14. Specifically, hitch-receiver pair 90 enables pivotal rotation (turning), pitch rotation, and oscillation or roll of trailer 16 with respect to tractor 14. Preferably, hitch-receiver pair 90 enables trailer 16 to pivot/turn within a range of ±95 degrees, as illustrated in FIG. 4, oscillate within a range of ±20 degrees, as illustrated in FIG. 5, and pitch within a range of ±20 degrees, as illustrated in FIGS. 6(a) and 6(b), with respect to tractor 14. As will be appreciated by one of skill in the art, hitching system 10 could be designed to pivot, pitch, and oscillate trailer 16 within a wide variety of ranges with respect to tractor 14.

In one embodiment, illustrated in FIG. 2, the hitch-receiver pair 90 has a spherical interface 54a with a ball hitch 50a and a corresponding ball socket 52a that is configured to receive the ball hitch 50a. The spherical interface 54a permits the hitch-receiver pair 90 to freely rotate without any kingpin constraining the movement. Accordingly, the ball hitch 50a freely pivots, oscillates, and pitches with respect to the ball socket 52a. Accordingly, trailer 16 is enabled to freely rotate by pivoting, oscillating, and pitching with respect to the tractor 14.

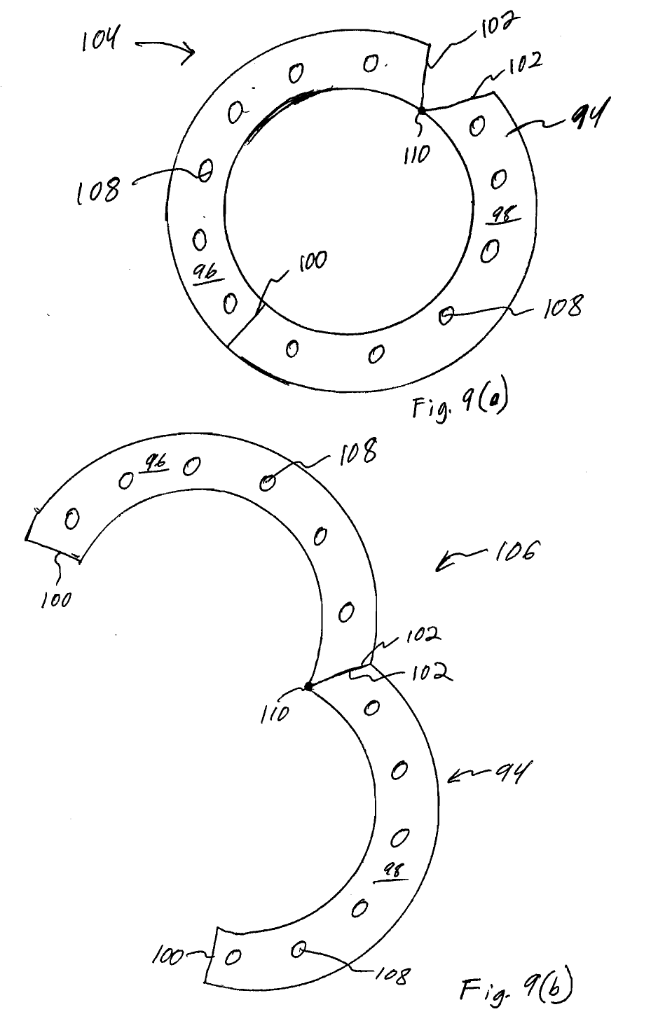

A locking ring 94, as illustrated in FIGS. 9(a) and 9(b), is positioned around the ball hitch 50a and secured to the ball socket 52a. Locking ring 94 includes a first hemi-spherical half 96 and a second hemi-spherical half 98 that are positioned together to secure the ball hitch 50a to the ball socket 52a. Each half 96 and 98 includes a split end 100 and a notched end 102 having a hinge 110 that enables the locking ring 94 to be opened and closed around the ball hitch 50a by pivoting the halves 96 and 98 about hinge 110. Specifically, FIG. 9(a) shows locking ring 94 in a closed position 104, and FIG. 9(b) illustrates locking ring 94 in an open position 106. Locking ring 94 further includes a plurality of apertures 108 through which a fastening mechanism, such as a screw or pin, is inserted to secure the locking ring 94 to the ball socket 52a. Accordingly, locking ring 94 operates to secure the ball hitch 50a to the ball socket 52a when the hitch-pair receiver 90 is in use.

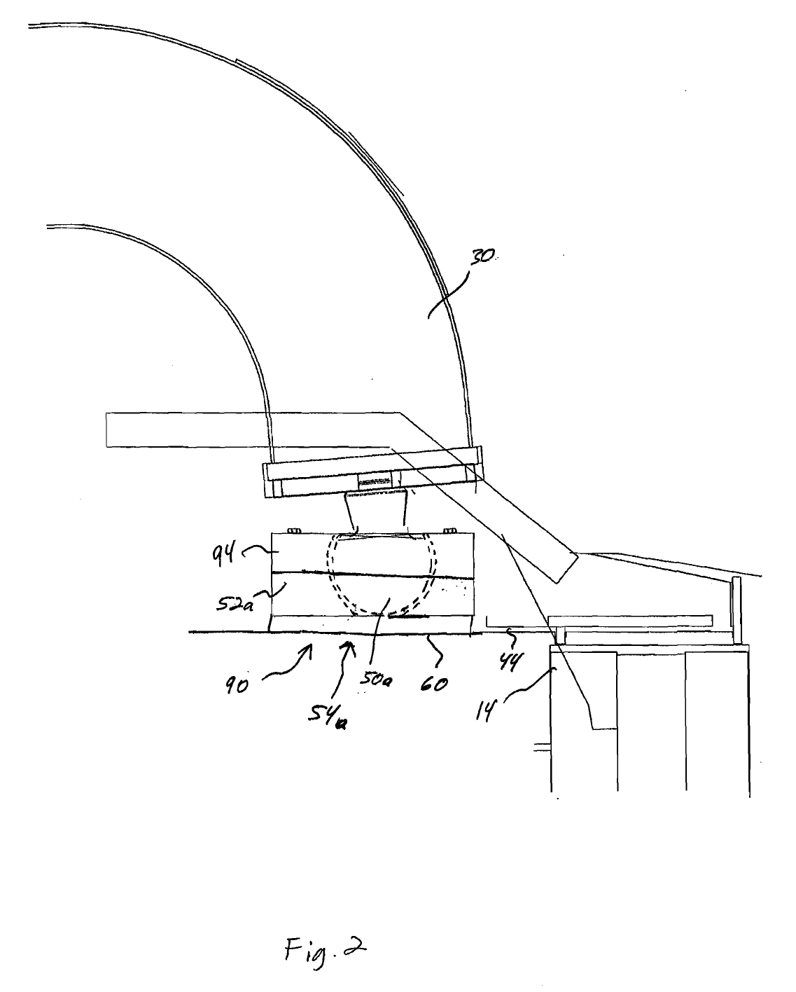

In another embodiment, illustrated in FIG. 3, the hitch-receiver pair 90 has a multi-joint interface 54b with a multi-pin hitch 50b that is configured to attach to the fixed receiver 52b. The multi-joint hitch 54b includes a pivot pin 66, a pitch pin 70, an oscillation pin 74, a first link 76, and a second link 78. First link 76 and second link 78 are coupled at their first ends 62 and 64 via oscillation pin 74, pivot pin 66 is attached to a second end 68 of first link 76, and pitch pin 70 is attached to a second end 72 of second link 78. First link 76 attaches to one of gooseneck 30 and base plate 60 via pivot pin 66, and second link 78 attaches to the other of gooseneck 30 and base plate 60 via pitch pin 70. The multi-joint hitch 50b is configured to pivot about pivot pin 66, pitch about pitch pin 70 and oscillate about oscillation pin 74 such that trailer 16 pivots, pitches, and oscillates with respect to tractor 14.

Accordingly, hitching system 10 enables trailer 16 to rotate freely with respect to tractor 14. In particular, the trailer 16 will pivot, pitch, and oscillate freely with respect to the tractor 14. This enables the tractor scraper 12 to operate on rough terrain with an unlevel grade without having the trailer 16 become detached from the trailer or otherwise inoperable.

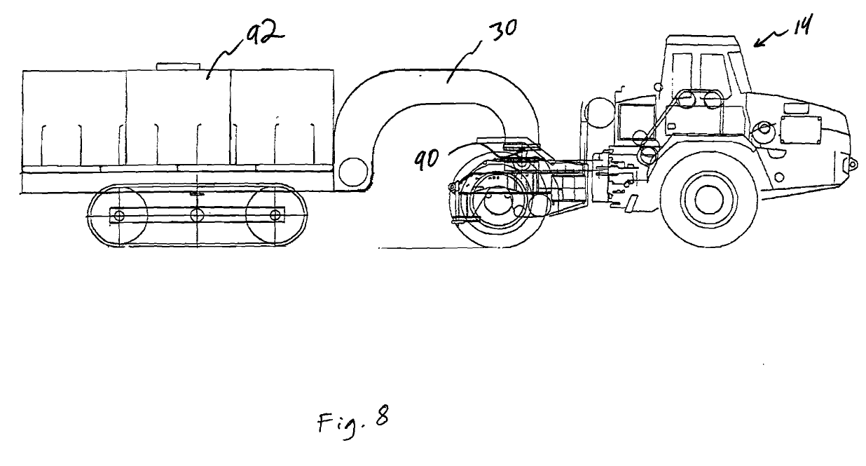

FIG. 8 is an illustration of tractor 14 having a water wagon 92 attached thereto using hitching system 10. As will be appreciated by one of ordinary skill in the art, hitching system 10 can be used to attach a water wagon and a dump trailer to tractor 14.

As various modifications could be made to the exemplary embodiments, as described above with reference to the corresponding illustrations, without departing from the scope of the invention, it is intended that all matter contained in the foregoing description and shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

What is claimed is:

1. A hitching system for a tractor, said system comprising:
a tractor having a frame, a rear axle, and a front axle, wherein said rear axle and said front axle are attached to said frame;
a gooseneck arm configured to attach to a trailer; and
a hitch-receiver pair comprising a hitch and a receiver, wherein said hitch is configured to fixedly attach to said receiver, one of said hitch and said receiver attached to said frame above and ahead of said rear axle, the other of said hitch and said receiver attached to said gooseneck, said hitch configured to freely rotate with respect to said receiver.

2. A hitching system according to claim 1, wherein said hitch freely pivots, pitches, and oscillates with respect to said receiver without a kingpin connection.

3. A hitching system according to claim 1, wherein said hitch-receiver pair is selected from the group consisting of a spherical interface and a multi-joint interface, said spherical interface comprising a ball hitch and a corresponding ball socket, and said multi-joint hitch comprising a multi-pin hitch and a fixed receiver.

4. A hitching system according to claim 3, wherein said hitch comprises a pivot component, a pitch component, and an oscillation component without a kingpin connection, wherein said hitch freely pivots within a range of approximately 190 degrees, freely pitches within a range of approximately 40 degrees, and freely oscillates within a range of approximately 40 degrees.

5. A hitching system according to claim 1 further comprising a base plate attached to said frame, one of said hitch and said receiver attached to said base plate.

6. A hitching system according to claim 1 further comprising a locking ring to secure said hitch to said receiver.

7. A hitching system for a trailer, said system comprising:
a trailer having a frame;
a gooseneck arm extending from said frame; and
a hitch-receiver pair comprising a hitch and a receiver, wherein said hitch is configured to fixedly attach to said receiver, one of said hitch and said receiver attached to said gooseneck arm, the other of said hitch and said receiver configured to coupled above and ahead of a rear axle of a tractor, said hitch configured to freely rotate with respect to said receiver.

8. A hitching system according to claim 7, wherein said hitch freely pivots, pitches, and oscillates with respect to said receiver, wherein said hitch pivots within a range of approximately 190 degrees, pitches within a range of approximately 40 degrees, and oscillates within a range of approximately 40 degrees.

9. A hitching system according to claim 8, wherein said hitch-receiver pair is selected from the group consisting of a spherical interface and a multi-joint interface, said spherical interface comprising a ball hitch and a corresponding ball socket, said multi-joint hitch comprising a multi-pin hitch and a fixed receiver, and said trailer is selected from the group consisting of a scraper, a water wagon and a dump trailer.

10. A hitching system according to claim 7, wherein said hitch is located above a rear axle of the tractor and a vector angle from a cutting edge of the trailer to said hitch comprises a minimal moment arm above the rear axle.

11. A tractor scraper comprising:
a tractor having a frame, a rear axle, and front axle, wherein said rear axle and said front axle are attached to said tractor frame;
a trailer having a frame;
a gooseneck arm extending from said trailer frame; and
a hitch-receiver pair comprising a hitch and a receiver, wherein said hitch is configured to fixedly attach to said receiver, one of said hitch and said receiver attached to said gooseneck arm, the other of said hitch and said receiver attached to said tractor frame above and ahead of said rear axle, said hitch configured to freely rotate with respect to said receiver.

12. A tractor scraper according to claim 11, wherein said hitch-receiver pair is selected from the group consisting of a spherical interface and a multi-joint interface, said spherical interface comprising a ball hitch and a corresponding ball socket, and said multi-joint hitch comprising a multi-pin hitch and a fixed receiver, and wherein said hitch freely pivots, pitches, and oscillates with respect to said receiver without a kingpin connection.

13. A tractor scraper according to claim 12, wherein said hitch is located approximately 16 inches ahead of and approximately 26.13 inches above a rear axle of the tractor.

14. A tractor scraper according to claim 13, wherein said hitch is located above a rear axle of the tractor and a vector angle from a cutting edge of the trailer to said hitch comprises a minimal moment arm above the rear axle.

15. A tractor scraper according to claim 12, wherein one of said hitch and said receiver is attached to said tractor frame above and ahead of said rear axle to distribute a weight of said trailer between said rear axle and said front axle.

16. A tractor scraper according to claim 12, wherein said hitch pivots within a range of approximately 190 degrees, pitches within a range of approximately 40 degrees, and oscillates within a range of approximately 40 degrees.

17. A tractor scraper according to claim 11, wherein one of said hitch and said receiver is centered between a first side and a second side of said tractor.

18. A tractor scraper according to claim 11, wherein said trailer is selected from the group consisting of a scraper, a water wagon and a dump trailer.

19. A tractor scraper according to claim 11, wherein said hitch-receiver provides a single mechanical connection between said tractor and said trailer without any kingpin connection.

20. A tractor scraper according to claim 11 further comprising a locking ring to secure said hitch to said receiver.
